(19) United States
(12) Patent Application Publication
(10) Pub. No.: US 2003/0115118 A1
(43) Pub. Date: Jun. 19, 2003

(54) Resource utilization management

(76) Inventor: Jeffrey K. Reinemann, Beaverton, OR (US)

Correspondence Address: FISH & RICHARDSON, PC, 4350 LA JOLLA VILLAGE DRIVE, SUITE 500, SAN DIEGO, CA, 92122, US

(21) Appl. No.: 10/024,503

(22) Filed: Dec. 17, 2001

(51) Int. Cl. G06F 17/60

(52) U.S. Cl. 705/30

(57) ABSTRACT

A network of processors share or trade their respective resources with others for improved resource utilization. The utilization of the resources is maintained within a predetermined upper threshold configured by an authorized user. Each of the processors includes an accounting manager that collects accounting information to monitor resources utilization at the processor; a policy manager that releases a portion of the resources to a remote one of the processors; and an out-of-range process that reduces availability of the resources when the upper threshold is exceeded.

### TECHNICAL FIELD

This invention relates to resource utilization management among a network of processors.

### BACKGROUND

FIG. 1 shows a plurality of processors 11, 12, 13 (only three are shown) connected by a network 15, which, for example, can be a LAN (Local Area Network), a WAN (Wide Area Network), or the Internet. Each of processors 11, 12, and 13 has resources locally controlled by the processor. Such resources may include, but are not limited to, DRAM memory, CPU (central processing unit) cycles, and disk storage 14A, 14B, and 14C.

The local resources at each of processors 11, 12, and 13 can be of different capacity, and users of the processors can require different levels of performance at different times. When one of processors 11, 12, and 13 are overloaded with processing tasks, the others may be underutilized or even idle. Such an imbalance in resource utilization is uneconomical in that neither the processing tasks are executed efficiently, nor the idling processors are utilized effectively.

### DESCRIPTION OF DRAWINGS

FIG. 1 is a diagram of processors connected by a network;

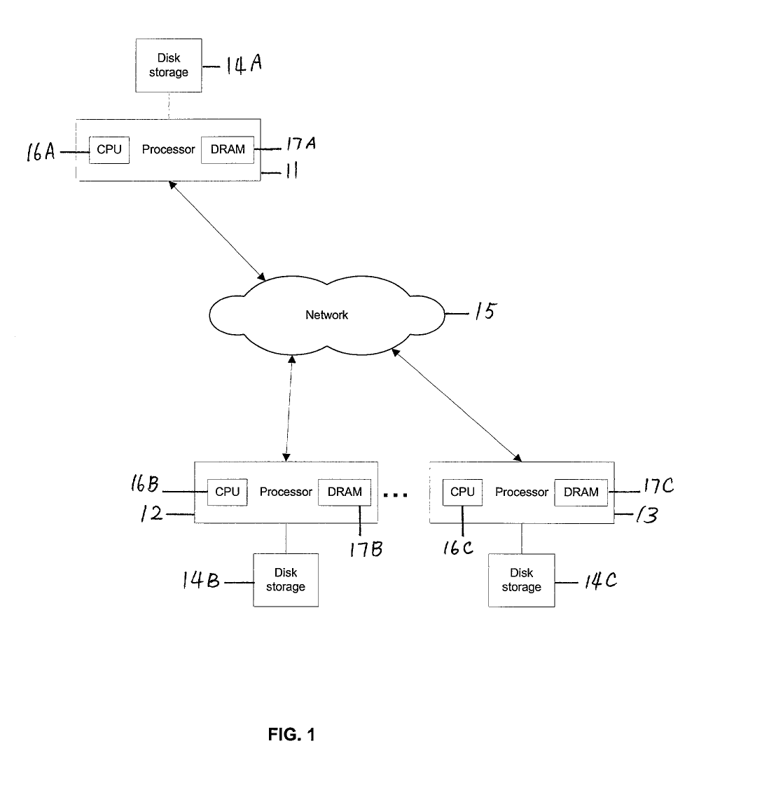

FIG. 2 is diagram of a processor that exchanges resources with other processors through the network;

FIG. 3 is a flow diagram of an accounting process run on the processor of FIG. 2;

FIG. 4 is a flow diagram of a policy manager that receives information from the accounting process and manages resource sharing based on that information; and

FIG. 5 is a flow diagram of an out-of-range process that is invoked by the policy manager when a pre-determined thershold on resource utilization is exceeded.

Like reference symbols in the various drawings indicate like elements.

### DETAILED DESCRIPTION

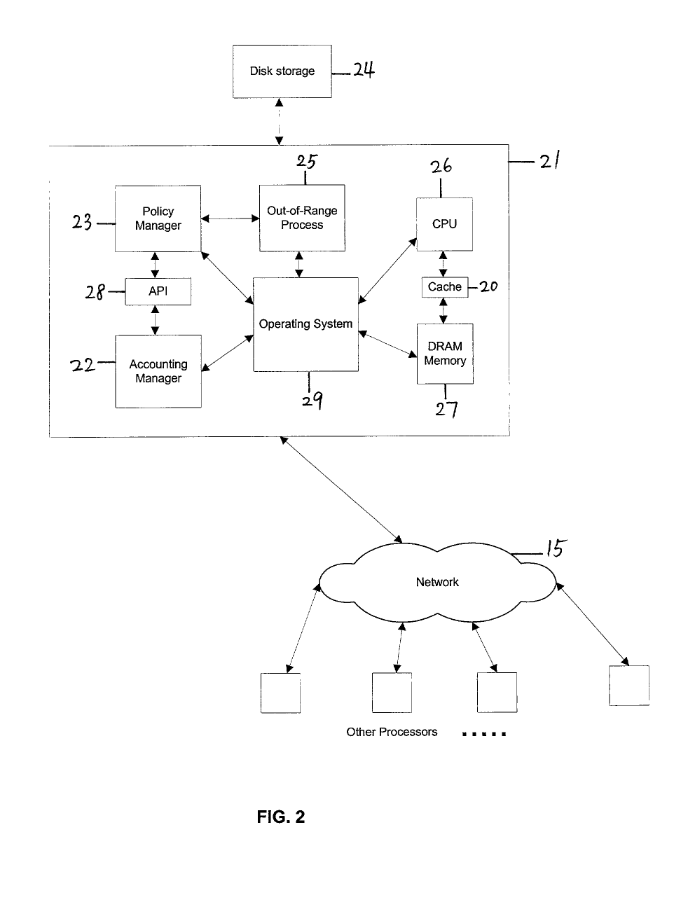

FIG. 2 shows a processor 21 connected to network 15, through which the processor may exchange information and data with other processors on the network. Processor 21 may also be configured by an authorized user to exchange an underutilized portion of its resources with the other processors. The authorized user, for example, can be an owner of processor 21 or a system administrator. Network 15 supports secure transmission, storage, and remote executions.

Utilization of the resources of processor 21 is monitored by an accounting manager 22. Accounting manager 22 executes an accounting process that collects performance status from the CPU 26, cache 20, DRAM memory 27, network traffic (not shown), operating system 29, and chipset performance counters (not shown). The performance status serves as an indication of resource utilization of processor 21. At a pre-determined time interval, the collected performance status is archived in a log file and stored at data storage 24.

An authorized user can define a policy for utilizing the resources of processor 21. The policy is enforced by an application called a policy manager 23, which obtains the performance status from accounting manager 22 through an API (Application Programmatic Interface) 28. After policy manager 23 reads the most recent performance status, it determines whether or not any of its resources can be shared by other processors on network 15 based on a policy defined by the user.

The policy includes parameters configured to specify a target range for each of the resources that are designated by the user as sharable. The target range is usually determined by a typical usage pattern of processor 21 and the network capacity that supports the sharing of the resources. The target range has an upper threshold and a lower threshold. When any of the sharable resources is operated below the lower threshold, the resource will become available to the other processors that are trusted by processor 21. When any of the sharable resources operates above the upper threshold, the resource is overloaded or close to be overloaded. In this situation, if the resource is currently shared by any of the other processors, policy manager 23 will discourage the other processors from using the resource by invoking an out-of-range process 25. More details on out-of-range process 25 will be discussed below.

In one scenario, e.g., in a corporate environment, a centralized server typically manages resources for the processors owned by the corporation. The server hosts a centralized policy manager, which monitors network traffic and manages resource utilization. Each of the processors runs a local policy manager that, based on information obtained from its accounting process, reports utilization and availability of its resources to the centralized policy manager. The local policy manager reports to the centralized policy manager upon receiving a query of performance status from the centralized policy manager. The local policy manager includes a query/response handshake mechanism that supports the reporting of the performance status.

Corporate system administrators can establish corporate-wide resource sharing policies among company-owned processors. In addition to using the target range to trigger resource sharing, system administrators can define configurable events for particular resources. Resource sharing is activated or de-activated when a configurable event occurs. Examples of the configurable events include idleness of the CPU and the hard disk drive for at least 20 minutes, and activation of the keyboard or the monitor session. When the CPU is idle for 20 minutes, the CPU processing cycles may be shared by the other processors. When the keyboard or the monitor session is activated, the resources shared by the other processors may be reduced or terminated.

The system administrators can also adopt a sharing policy that collects the resources of all the processors in a resource pool. The sharing policy specifies an upper limit, based on the age of the processor, for the amount of resources that a processor can consume from the resource pool. For example, suppose that each processor is used over a three-year lifespan, and therefore has an age between zero and three. When the processor reaches three years of age, the processor will be replaced by an upgraded model. During the first year (i.e., at age zero), the processor can consume 20% less resources than the total resources that it contributes to the resource pool. During the second year (i.e., at age one), the processor can consume all of the resources that it contributes to the resource pool. In the third year (i.e., at age two), the processor can consume 20% more resources than the total resources that it contributes to the resource pool. The amount of resources consumed by the processor will be tracked by the corresponding local policy manager and the centralized policy manager.

This approach assures that the end users have processors with increased performance over the years, even though the processors have not increased their capabilities over that time frame. The system administrators can also allocate more resources from the resource pool to users based on the amount of resources they need, thereby increasing the flexibility of resource allocation.

In another scenario, e.g., in a home environment, a user can configure his policy manager 23 to specify the types and amount of resources he is willing to “trade” or “barter” with other processors. The user can also purchase resources from the other processors, earn credits from providing his resources to the other processors, or receive rights for future usage of the resources from the other processors. This approach allows the user to leverage excess resources and to utilize more resources during peak usage.

For example, a user A identifies that he has an extra 10GB hard disk storage, but needs additional computational power. A user B identifies that he has 20% extra processing cycles and an amount of extra DRAM memory corresponding to the 20% processing cycles, but needs additional disk storage space. After the excess of the resources is identified, the policy managers 23 on the two users' processors search for a processor to offer an exchange of resources. The two policy managers 23 find each other and start negotiating the terms of exchange. The negotiation is based on resource exchange values specified by the two users. For example, the users can specify that X% processing cycles and Y% DRAM memory utilization is equivalent to Z% disk storage.

After the terms of exchange are agreed by both users A and B, user A's processor can send a computational task to user B's processor and user B can store data on user A's hard disk drive for a pre-determined time period.

Policy manager 23 can also be configured to automatically negotiate resource exchanges with other processors. For example, a user can configure policy manager 23 to find the best offer within a given duration of time. Moreover, for each sharable resource, policy manager 23 can support multiple. lower thresholds below which the resource will become available to other processors. Each of the lower thresholds is designated for a specific time duration. As a result, more resources can be shared with other processors while the user is not using the resources. Additionally, policy manager 23 can also support a user-override capability to allow a user to initiate or terminate sharing regardless of current policy configurations. With the user-override capability, a user can offer an idle resource that is typically in use at the time of offer in exchange for current or future usage of resources from other processors, or can stop the sharing when the user needs to reclaim the shared resources. When the user receives the future usage from the other processors, the usage can be realized at a negotiated future time for a negotiated period.

A variation of the home environment scenario is described below in which a centralized service provider, e.g., an Internet Service Provider (ISP) brokers the exchange of resources for the users that subscribe to the exchange service. The exchange of resources is time based, that is, the resources that a user provides or consumes are limited to a pre-determined time period.

In the ISP scenario, the policy manager 23 residing on each user's processor acts as an agent on behalf of that user. Each policy manager 23, instead of negotiating with other users directly, negotiates with the ISP's policy manager. The ISP credits the users who share resources through the ISP with either real currency, valuable goods, or discount coupons for retail items. The ISP can alternatively grant an equivalent credit to the users redeemable at a future time. The credit can be redeemed for additional resources when needed.

The policy manager 23 on a user's processor keeps a record of the user's outstanding credits, and queries the ISP's policy manager for the current credits in the user's account to verify the record. The policy manager 23 also maintains billing information for the user. The billing information includes the amount of each resource that is consumed by the user and supplied to the other processors.

In the above scenarios, each of the shared resources is closely monitored to assure the overall utilization of that resource is within the pre-determined upper threshold of the target range, the value of which can vary from one resource to another. The upper threshold indicates a limit to the total utilization of the corresponding resource beyond which the resource will be overloaded. Accounting manager 22 monitors the current usage of the resources and returns the information to policy manager 23. For example, suppose user A is allowed to run a process that shares 20% of CPU cycles on user B's processor. If A's usage later increases to above 20%, or if the total utilization of B's CPU exceeds the upper threshold (e.g., 70%), B's policy manager 23 can, when either or both of the situations occur, invoke out-of-range process 25 to reduce A's usage. An approach that can be taken by out-of-range process 25 is to lower the priority of A's process on B's processor to bring it back down to the negotiated 20% level.

Out-of-range process 25 allows users participating in the resource sharing to maintain sufficient resources for their own use. Users that consume resources more than the negotiated level can be detected and discouraged. As a result, the impact of resource sharing on network 15 can also be controlled.

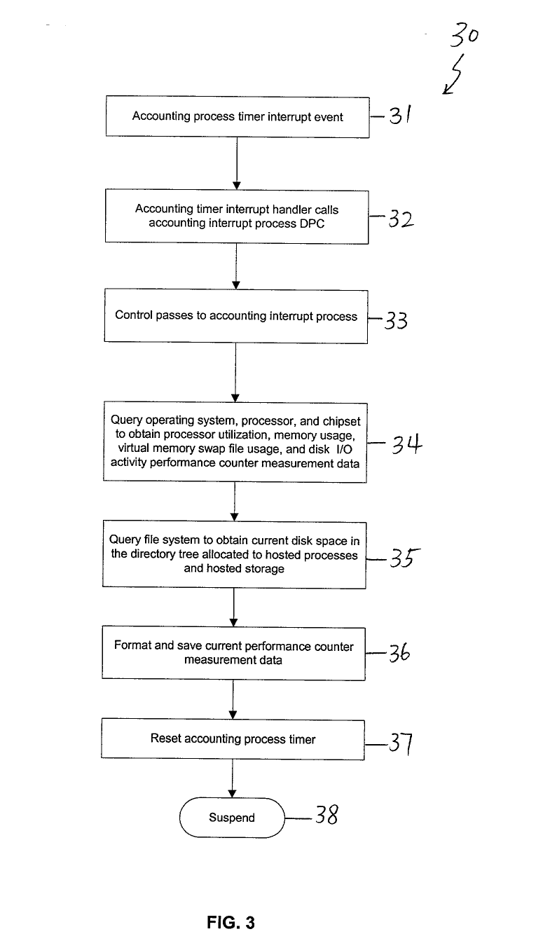

In FIGS. 3, 4, and 5, examples of the processes executed on accounting manager 22, policy manager 23, and out-of-range process 25 are described.

FIG. 3 shows an example of an accounting process 30 executed by accounting manager 22 on processor 21. Processor 21 shares its CPU 26 processing cycles, DPAM memory 27, and disk storage 24 with other trusted processors. The processes spawned by the other processors and storage acquired by the other processors are called hosted processes and hosted storage, respectively. Accounting process 30 runs an accounting timer that generates an accounting timer interrupt event periodically. When the accounting timer interrupt event occurs (box 31), an accounting timer interrupt handler calls accounting interrupt process DPC (Deferred Procedural Call) (box 32). The accounting interrupt process DPC passes control to an accounting interrupt process (box 33), which queries operating system 29, processing units, and chipset to obtain processor utilization, memory usage, virtual memory swap file usage, and disk I/O activity performance counter measurement data (box 34). The accounting interrupt process also queries the file system of the host processor to obtain current disk space that is allocated to hosted processes and hosted storage (box 35).

After gathering the measurement data, the accounting interrupt process formats and saves the data in a log file (box 36), and then resets accounting process timer (box 37). Following the reset, accounting process 30 is suspended (box 38) until the next timer interrupt event occurs (box 31).

The log file generated by accounting process 30 is used by policy manager 23 to determine the utilization of processor 21, as will be described below.

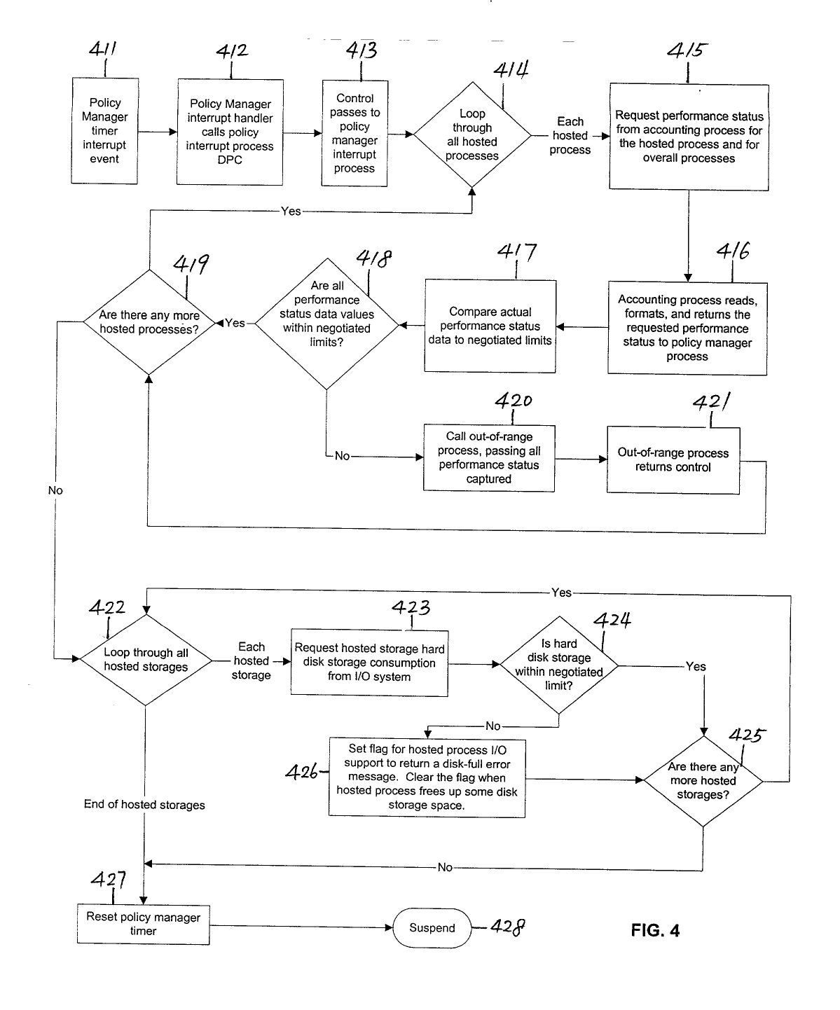

FIG. 4 shows an example of a policy manager process 40 executed by policy manager 23. Similar to accounting process 30, policy manager process 40 configures a policy manager timer that generates a policy manager interrupt event periodically. When the policy manager timer interrupt event occurs (box 411), an interrupt handle calls a policy interrupt process DPC (box 412). The policy interrupt process DPC passes control to a policy manager interrupt process (box 413), which starts looping through all hosted processes upon receiving the control (box 414).

For each hosted process, the policy manager interrupt process requests accounting process 30 for current processor utilization, memory utilization, and disk I/O activity performance counter measurement data (box 415). The requested information includes the performance status of not only the hosted process, but also the overall processes that run on processor 21. When accounting process 30 receives the request, it reads the requested performance status from the stored log file, formats and returns the status to policy manager process 40 (box 416).

Policy manager process 40 compares the returned performance status data to the target ranges for the resources of processor 21 (box 417). If the performance status data is within the target ranges (box 418), policy manager process 40 checks to see if there are any more hosted processes that have not been examined (box 419). If there is at least one more hosted process, policy manager process 40 repeats the operation described in boxes 414-419. If all the hosted processes have been examined, policy manager process 40 will examine the hosted storage (box 422).

If at box 418, the performance status data exceeds the upper threshold for any of the resources except disk storage 24, policy manager process 40 calls an out-of-range process 25, passing all performance status data captured, to handle the situation (box 420). After out-of-range process 25 returns control to policy manager process 40 (box 421), process manager process 40 will either continue to examine the next hosted process if at least one of them has not been examined (boxes 414-421), or otherwise start to examine the hosted storages (box 422).

Policy manager process 40 loops through all the hosted storages (box 422). For each hosted storage, policy manager process 40 requests hard disk storage consumption from the I/O system (box 423). Policy manager process 40 checks to see if the hard disk storage consumption exceeds the negotiated limit (box 424). If the consumption exceeds the limit, policy manager process 40 sets a flag, causing a hosted process I/O support to return a disk-full error message. The flag is cleared when the hosted process frees up the disk-storage space that is above the limit (box 426).

If the disk storage consumption is below the limit (box 424), or appropriate actions described in box 426 have been performed, policy manager process 40 determines if there are any more hosted storages that have not been examined (box 425). If there is at least one such hosted storage, policy manager process 40 repeats the operations described in boxes 422-426. Otherwise, policy manager process 40 resets the policy manager timer (box 427) and enters a suspended state (box 428). Policy manager process 40 will exit the suspended state when the policy manager timer interrupt event occurs again (box 411).

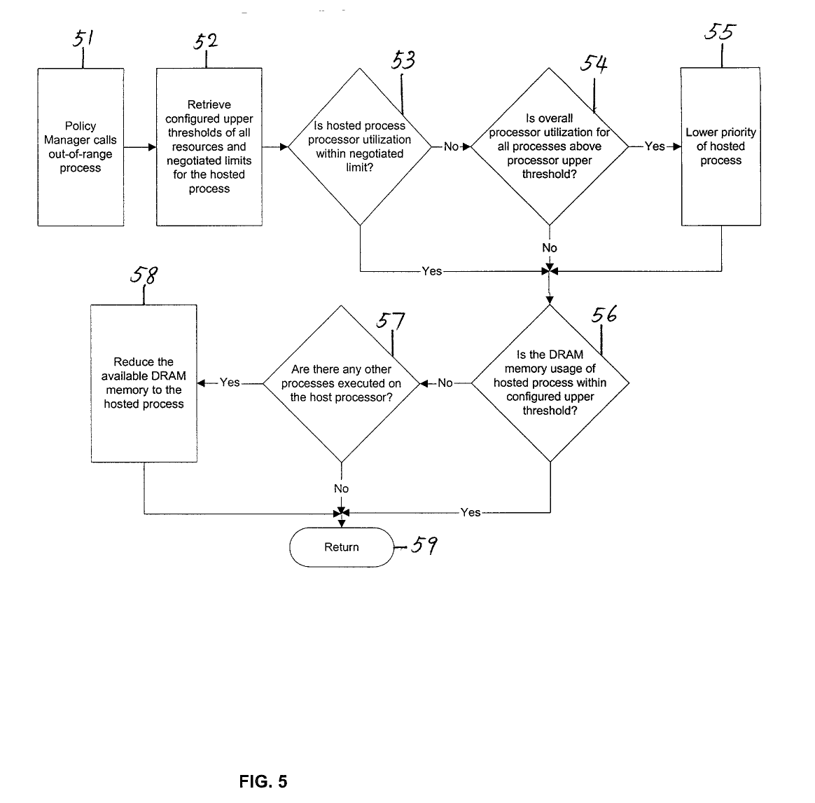

FIG. 5 shows an example of out-of-range process 25. When policy manager process 40 calls out-of-range process 25 (box 51) and passes the performance status data, at least one of the upper thresholds of the resources of processor 21 has been violated by a particular hosted process. Out-of-range process 25 first retrieves configured upper thresholds for all the resources and the negotiated limits for the hosted process (box 52). Based on the configured values, the negotiated limit, and the performance status data, out-of-range process 25 examines the processor utilization of processor 21 to determine whether or not the processor utilization of the hosted process has exceeded the negotiated limit (box 53). If the utilization has exceeded the negotiated limit, out-of-range process 25 further examines if the overall processor utilization for all processes on processor 21 is above the upper threshold (box 54). If the upper threshold is also exceeded, out-of-range process 25 throttles the hosted process by, e.g., lowering the priority of the hosted process (box 55).

If neither the limit nor the threshold is met or exceeded, or appropriate action has been performed as described in box 55, out-of-range process 25 continues to examine the DRAM memory usage of processor 21 (box 56). If the DRAM memory usage exceeds the upper threshold, out-of-range process 25 further examines if any other process is also executed on processor 21 (box 57). If there is at least one other process, out-of-range process 25 reduces the available DRAM memory for the hosted process (box 58).

If the threshold has not been exceeded, or no other hosted process is executed on processor 21, or appropriate action has been performed as described in box 58, out-of-range process 25 returns control to policy manager process 40 (box 59).

Accordingly, other embodiments are within the scope of the following claims.

What is claimed is:

1. A method of managing resources among networked processors that include a host processor and a remote processor, the method comprising:
collecting accounting information at each of the networked processors to monitor utilization of the resources;
releasing a local resource controlled by the host processor to the remote processor, the utilization of the local resource maintained within a pre-determined upper threshold configured by an authorized user; and
if the upper threshold is exceeded, reducing availability of the local resource to the remote processor.

2. The method of claim 2 further comprising:
negotiating an amount of the local resource and an amount of a remote resource between the host processor and the remote processor; and
releasing the amount of the local resource in exchange for receiving the amount of the remote resource.

3. The method of claim 2 wherein the releasing and the receiving occur at substantially different times.

4. The method of claim 1 further comprising acquiring another resource from one of the processors.

5. The method of claim 4 wherein the acquiring and the releasing occur at substantially different times.

6. The method of claim 4 wherein the acquiring and the releasing are negotiated indirectly at a centralized location.

7. The method of claim 1 further comprising releasing the local resource in exchange for a credit redeemable at a future time.

8. The method of claim 1 wherein reducing availability of the local resource includes lowering a priority of the remote processor.

9. The method of claim 1 wherein the releasing is triggered when a user-defined condition is met.

10. A resource management system comprising:
a network;
processors connected by the network, each of the processors including:
resources, the utilization of which is maintained within a pre-determined upper threshold configured by an authorized user;
an accounting manager that collects accounting information to monitor the utilization;
a policy manager that releases a portion of the resources to a remote one of the processors; and
an out-of-range process that reduces availability of the resources when the upper threshold is exceeded.

11. The system of claim 10 wherein the policy manager negotiates with the remote processor to determine the portion of the resources to be released in exchange for receiving a remote resource from the remote processor.

12. The system of claim 11 wherein the policy manager releases and receives at substantially different times.

13. The system of claim 10 wherein the policy manager acquires another resource from one of the processors.

14. The system of claim 13 wherein the policy manager acquires and releases at substantially different times.

15. The system of claim 14 further comprising a centralized server through which the acquiring and the releasing are negotiated.

16. The system of claim 10 wherein the policy manager releases the local resource in exchange for a credit redeemable at a future time.

17. The system of claim 10 wherein the out-of-range process reduces availability of the resources by lowering a priority of the remote processor.

18. The system of claim 11 wherein the policy manager releases the portion of the resources when when a user-defined condition is met.

19. A computer program product residing on a computer readable medium comprising instructions for causing the computer to:
collect accounting information at each of the networked processors to monitor utilization of the resources;
release a local resource controlled by the host processor to the remote processor, the utilization of the local resource maintained within a pre-determined upper threshold configured by an authorized user; and
if the upper threshold is exceeded, reduce availability of the local resource to the remote processor.

20. The computer program product of claim 19 further comprising instructions for causing the computer to:
negotiate an amount of the local resource and an amount of a remote resource between the host processor and the remote processor; and
release the amount of the local resource in exchange for receiving the amount of the remote resource.

21. The computer program product of claim 20 further comprising instructions for causing the computer to release the local resource and receive the remote resource at substantially different times.

22. The computer program product of claim 19 further comprising instructions for causing the computer to acquire another resource from one of the processors.

23. The computer program product of claim 22 further comprising instructions for causing the computer to acquire the other resource and release the local resource at substantially different times.

24. The computer program product of claim 22 further comprising instructions for causing the computer to negotiate indirectly at a centralized location.

25. The computer program product of claim 19 further comprising instructions for causing the computer to release the local resource in exchange for a credit redeemable at a future time.

26. The computer program product of claim 19 further comprising instructions for causing the computer to lower a priority of the remote processor to reduce the availability of the local resource.
